(19) United States
(12) Patent Application Publication
(10) Pub. No.: US 2024/0104783 A1
(43) Pub. Date: Mar. 28, 2024

(54) MULTIPLE ATTRIBUTE MAPS MERGING

(71) Applicant: TENCENT AMERICA LLC, Palo Alto, CA (US)

(72) Inventors: Fang-yi CHAO, Palo Alto, CA (US); Thuong Nguyen Canh, Palo Alto, CA (US); Xiang Zhang, Palo Alto, CA (US); Xiaozhong Xu, Palo Alto, CA (US); Shan Liu, Palo Alto, CA (US)

(73) Assignee: TENCENT AMERICA LLC, Palo Alto, CA (US)

(21) Appl. No.: 18/314,307

(22) Filed: May 9, 2023

Related U.S. Application Data
(60) Provisional application No. 63/408,994, filed on Sep. 22, 2022.

(51) Int. Cl. G06T 9/00; G06T 7/40

(52) U.S. Cl. CPC G06T 9/001; G06T 7/40

(57) ABSTRACT

Method, apparatus, and system for merging multiple attribute maps for mesh compression may be provided. The process may include obtaining multiple attribute maps associated with a mesh including one or more texture maps. The multiple attribute maps may be concatenated into a single concatenated map and concatenated UV coordinates for each of the multiple attribute maps may be generated based on re-computing original UV coordinates of each of the multiple attribute maps within the single concatenated map.

### CROSS-REFERENCE TO RELATED APPLICATION

This application claims priority from U.S. Provisional Application No. 63/408,994, filed on Sep. 22, 2022, the disclosure of which is incorporated herein by reference in its entirety.

### FIELD

This disclosure is directed to a set of advanced video coding technologies. More specifically, the present disclosure is directed to dynamic mesh compression based on multiple attribute maps merging.

### BACKGROUND

Advanced three-dimensional (3D) representations of the world are enabling more immersive forms of interaction and communication. To achieve realism in 3D representations, 3D models are becoming ever more sophisticated, and a significant amount of data is linked to the creation and consumption of these 3D models. 3D meshes are widely used to 3D model immersive content.

A 3D mesh may include several polygons that describe the surface of a volumetric object. Each polygon is defined by its vertices in 3D space and the information on how the vertices are connected, referred to as connectivity information. In some embodiments, vertex attributes, such as colors, normals, etc., could be associated with the mesh vertices. Attributes could also be associated with the surface of the mesh by exploiting mapping information that parameterizes the mesh with 2D attribute maps. Such mapping may usually be described by a set of parametric coordinates, referred to as UV coordinates or texture coordinates, associated with the mesh vertices. 2D attribute maps are used to store high-resolution attribute information such as texture, normals, displacements, etc. Such information could be used for various purposes such as texture mapping and shading.

A dynamic mesh sequence may require a large amount of data since it may have a significant amount of information changing over time. Therefore, efficient compression technologies are required to store and transmit such contents.

While mesh compression standards IC, MESHGRID, FAMC were previously developed to address dynamic meshes with constant connectivity and time varying geometry and vertex attributes. However, these standards do not take into account time varying attribute maps and connectivity information.

While common test condition is used to evaluate the performance of a compression scheme, at least for static meshes the evaluation may not be consistent. Therefore, methods and systems are needed to fit in the evaluation system consistently.

### SUMMARY

According to embodiments, a method for merging multiple attribute maps for mesh compression may be provided. The method may include obtaining multiple attribute maps associated with a mesh, wherein the multiple attribute maps comprise two or more texture maps associated with the mesh; generating a single concatenated map based on concatenating the multiple attribute maps; and generating concatenated UV coordinates for each of the multiple attribute maps based on re-computing original UV coordinates of each of the multiple attribute maps within the single concatenated map.

According to embodiments, an apparatus for merging multiple attribute maps for mesh compression may be provided. The apparatus may include at least one memory configured to store program code; and at least one processor configured to read the program code and operate as instructed by the program code. The program code may include obtaining code configured to cause the at least one processor to obtain multiple attribute maps associated with a mesh, wherein the multiple attribute maps comprise two or more texture maps associated with the mesh; first generating code configured to cause the at least one processor to generate a single concatenated map based on concatenating the multiple attribute maps; and second generating code configured to cause the at least one processor to generate concatenated UV coordinates for each of the multiple attribute maps based on re-computing original UV coordinates of each of the multiple attribute maps within the single concatenated map.

According to embodiments, a non-transitory computer-readable medium stores computer instructions may be provided. The instructions may include one or more instructions that, when executed by one or more processors of a device for merging multiple attribute maps for mesh compression, cause the one or more processors to obtain multiple attribute maps associated with a mesh, wherein the multiple attribute maps comprise two or more texture maps associated with the mesh; generate a single concatenated map based on concatenating the multiple attribute maps; and generate concatenated UV coordinates for each of the multiple attribute maps based on re-computing original UV coordinates of each of the multiple attribute maps within the single concatenated map.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of a simplified block diagram of a communication system, in accordance with embodiments of the present disclosure.

FIG. 2 is a schematic illustration of a simplified block diagram of a streaming system, in accordance with embodiments of the present disclosure.

FIG. 3 is a schematic illustration of a simplified block diagram of a video encoder and decoder, in accordance with embodiments of the present disclosure.

FIG. 4 is a an exemplary proposed framework of common text condition for lossy mesh compression, in accordance with embodiments of the present disclosure.

FIG. 5 is a flow diagram illustrating a texture map merging pipeline, in accordance with embodiments of the present disclosure.

FIG. 6 is an exemplary concatenated texture map illustration concatenation and pixel padding, in accordance with embodiments of the present disclosure.

FIG. 7A-7B are exemplary texture maps illustrating concatenation of texture maps, in accordance with embodiments of the present disclosure.

FIG. 8 is an exemplary texture map illustrating concatenation of texture maps, in accordance with embodiments of the present disclosure.

FIG. 9A-9B are exemplary texture maps illustrating concatenation of texture maps, in accordance with embodiments of the present disclosure.

FIG. 10A-10B are exemplary texture maps illustrating concatenation of texture maps, in accordance with embodiments of the present disclosure.

FIG. 11 is an exemplary flow diagram illustrating multiple attribute maps merging, in accordance with embodiments of the present disclosure.

FIG. 12 is a diagram of a computer system suitable for implementing embodiments.

### DETAILED DESCRIPTION

A mesh may include several polygons that describe the surface of a volumetric object. Its vertices in 3D space and the information of how the vertices are connected may define each polygon, referred to as connectivity information. Optionally, vertex attributes, such as colors, normals, etc., may be associated with the mesh vertices. Attributes may also be associated with the surface of the mesh by exploiting mapping information that parameterizes the mesh with 2D attribute maps. Such mapping may be defined using a set of parametric coordinates, referred to as UV coordinates or texture coordinates, and associated with the mesh vertices. 2D attribute maps may be used to store high resolution attribute information such as texture, normals, displacements etc. The high resolution attribute information may be used for various purposes such as texture mapping and shading.

As stated above, a 3D mesh or dynamic meshes may require a large amount of data since it may consist of a significant amount of information changing over time. Existing standards do not take into account time varying attribute maps and connectivity information. Existing standards also do not support volumetric acquisition techniques that generate a constant connectivity dynamic mesh, especially under real-time conditions.

While common test condition is used to evaluate the performance of a compression scheme, at least for static meshes the evaluation may not be consistent. Therefore, methods and systems are needed to fit in the evaluation system consistently.

Therefore, to fit in the evaluation system consistently, especially for those meshes with multiple attribute maps, the attribute maps, e.g., texture maps, are concatenated to become a single attribute map. The UV coordinates of each attribute map may be recalculated to the corresponding size and location in the single concatenated attribute map. Attribute map merging, e.g., texture map merging, may be considered a pre-processing step for mesh compression of meshes with multiple attribute maps and multiple texture maps.

According to an aspect of the present disclosure, methods, systems, and non-transitory storage mediums for merging attribute maps during dynamic mesh compression are provided. Embodiments of the present disclosure may also be applied to static meshes.

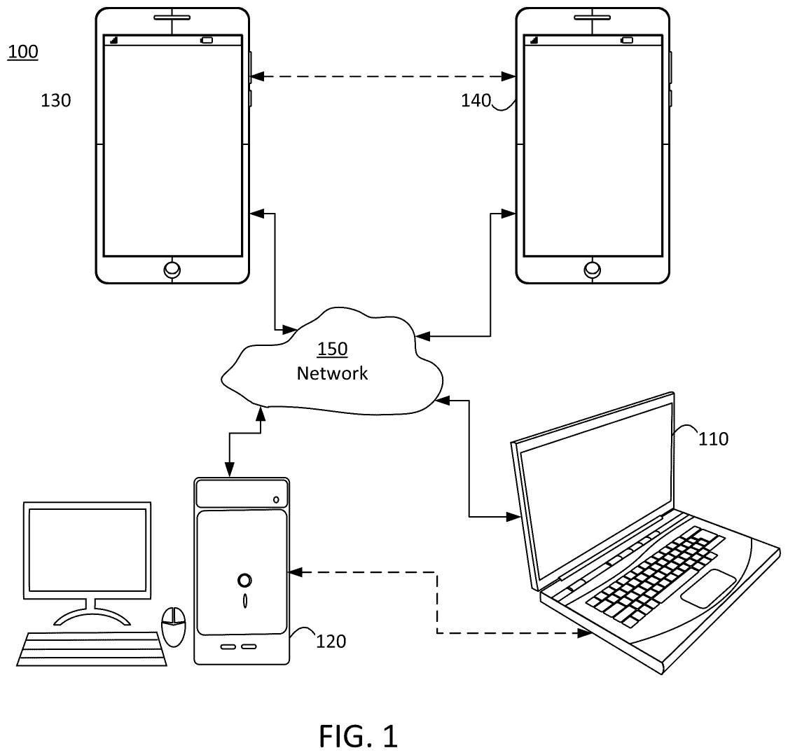

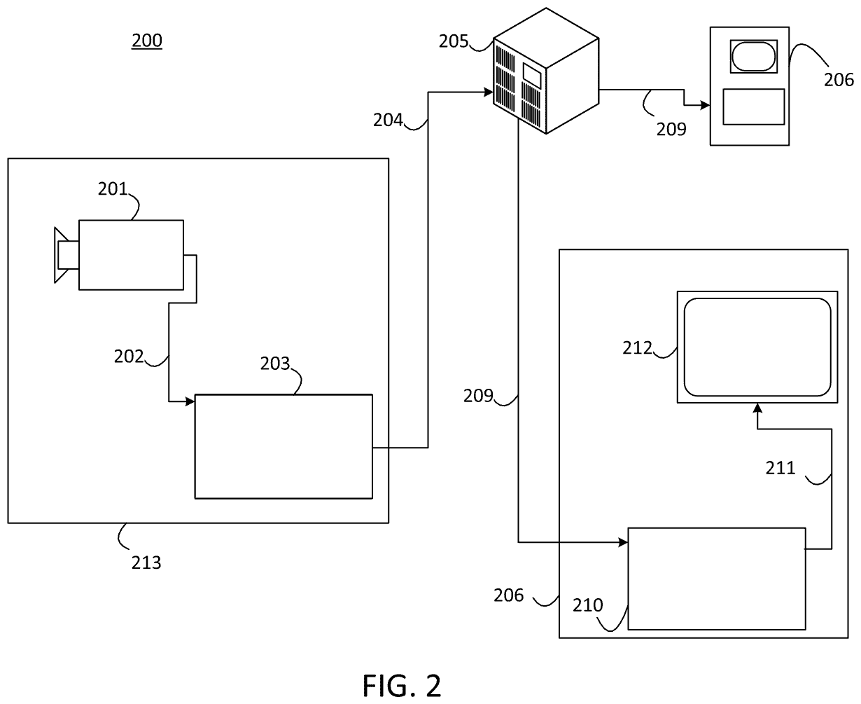

With reference to FIGS. 1-2, an embodiment of the present disclosure for implementing encoding and decoding structures of the present disclosure are described.

FIG. 1 illustrates a simplified block diagram of a communication system 100 according to an embodiment of the present disclosure. The system 100 may include at least two terminals 110, 120 interconnected via a network 150. For unidirectional transmission of data, a first terminal 110 may code video data, which may include mesh data, at a local location for transmission to the other terminal 120 via the network 150. The second terminal 120 may receive the coded video data of the other terminal from the network 150, decode the coded data and display the recovered video data. Unidirectional data transmission may be common in media serving applications and the like.

FIG. 1 illustrates a second pair of terminals 130, 140 provided to support bidirectional transmission of coded video that may occur, for example, during videoconferencing. For bidirectional transmission of data, each terminal 130, 140 may code video data captured at a local location for transmission to the other terminal via the network 150. Each terminal 130, 140 also may receive the coded video data transmitted by the other terminal, may decode the coded data and may display the recovered video data at a local display device.

In FIG. 1, the terminals 110-140 may be, for example, servers, personal computers, and smart phones, and/or any other type of terminals. For example, the terminals (110-140) may be laptop computers, tablet computers, media players and/or dedicated video conferencing equipment. The network 150 represents any number of networks that convey coded video data among the terminals 110-140 including, for example, wireline and/or wireless communication networks. The communication network 150 may exchange data in circuit-switched and/or packet-switched channels. Representative networks include telecommunications networks, local area networks, wide area networks, and/or the Internet. For the purposes of the present discussion, the architecture and topology of the network 150 may be immaterial to the operation of the present disclosure unless explained herein below.

FIG. 2 illustrates, as an example of an application for the disclosed subject matter, a placement of a video encoder and decoder in a streaming environment. The disclosed subject matter can be used with other video enabled applications, including, for example, video conferencing, digital TV, storing of compressed video on digital media including CD, DVD, memory stick and the like, and so on.

As illustrated in FIG. 2, a streaming system 200 may include a capture subsystem 213 that includes a video source 201 and an encoder 203. The streaming system 200 may further include at least one streaming server 205 and/or at least one streaming client 206.

The video source 201 can create, for example, a stream 202 that includes a 3D mesh and metadata associated with the 3D mesh. The video source 201 may include, for example, 3D sensors (e.g. depth sensors) or 3D imaging technology (e.g. digital camera(s)), and a computing device that is configured to generate the 3D mesh using the data received from the 3D sensors or the 3D imaging technology. The sample stream 202, which may have a high data volume when compared to encoded video bitstreams, can be processed by the encoder 203 coupled to the video source 201. The encoder 203 can include hardware, software, or a combination thereof to enable or implement aspects of the disclosed subject matter as described in more detail below. The encoder 203 may also generate an encoded video bitstream 204. The encoded video bitstream 204, which may have e a lower data volume when compared to the uncompressed stream 202, can be stored on a streaming server 205 for future use. One or more streaming clients 206 can access the streaming server 205 to retrieve video bit streams 209 that may be copies of the encoded video bitstream 204.

The streaming clients 206 can include a video decoder 210 and a display 212. The video decoder 210 can, for example, decode video bitstream 209, which is an incoming copy of the encoded video bitstream 204, and create an outgoing video sample stream 211 that can be rendered on the display 212 or another rendering device (not depicted). In some streaming systems, the video bitstreams 204, 209 can be encoded according to certain video coding/compression standards.

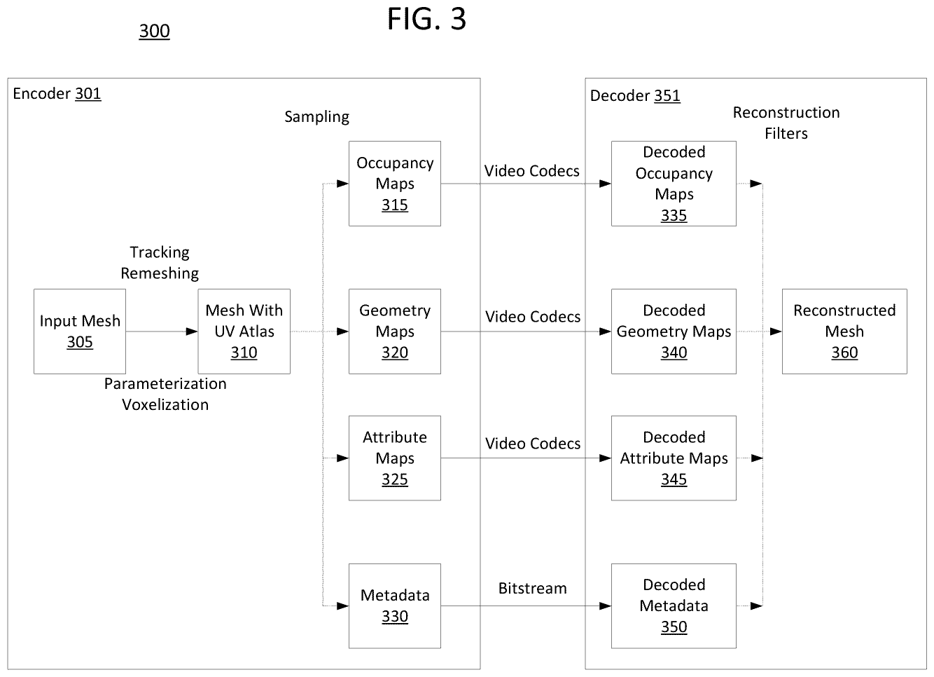

FIG. 3 is an exemplary diagram of framework 300 for dynamic mesh compression and mesh reconstruction using encoders and decoders.

As seen in FIG. 3, framework 300 may include an encoder 301 and a decoder 351. The encoder 301 may include one or more input mesh 305, one or more mesh with UV atlas 310, occupancy maps 315, geometry maps 320, attribute maps 325, and metadata 330. The decoder 351 may include decoded occupancy maps 335, decoded geometry maps 340, decoded attribute maps 345, decoded metadata 350, and reconstructed mesh 360.

As stated above, attributes may be associated vertices or with the surface of the mesh by exploiting mapping information that parameterizes the mesh with 2D attribute maps. Such mapping may be defined using a set of parametric coordinates, referred to as UV coordinates or texture coordinates, and associated with the mesh vertices. 2D attribute maps may be used to store high resolution attribute information such as texture, normals, displacements etc. The high resolution attribute information may be used for various purposes such as texture mapping and shading. 3D attribute maps may be used to store a plurality of attributes for nodes in the mesh.

According to an aspect of the present disclosure, the input mesh 305 may include one or more frames, and each of the one or more frames may be preprocessed by a series of operations and used to generate the mesh with UV atlas 310. As an example, the preprocessing operations may include and may not be limited to tracking, parameterization, remeshing, voxelization, etc. In some embodiments, the preprocessing operations may be performed only on the encoder side and not the decoder side.

The mesh with UV atlas 310 may be a 2D mesh. The 2D mesh with UV atlas may be a mesh in which each vertex of the mesh may be associated with UV coordinates on a 2D atlas. The mesh with the UV atlas 310 may be processed and converted into a plurality of maps based on sampling. As an example, the UV atlas 310 may be processed and converted into occupancy maps, geometry maps, and attribute maps based on sampling the 2D mesh with UV atlas. The generated occupancy maps 335, geometry maps 340, and attribute maps 345 may be encoded using appropriate codecs (e.g., HVEC, VVC, AV1, etc.) and transmitted to a decoder. In some embodiments, metadata (e.g., connectivity information etc.) may also be transmitted to the decoder.

According to an aspect, the decoder 351 may receive the encoded occupancy maps, geometry maps, and attribute maps from an encoder. The decoder 351 may use appropriate techniques and methods, in addition to embodiments described herein, to decode the occupancy maps, geometry maps, and attribute maps. In an embodiment, decoder 351 may generate decoded occupancy maps 335, decoded geometry maps 340, decoded attribute maps 345, and decoded metadata 350. The input mesh 305 may be reconstructed into reconstructed mesh 360 based on the decoded occupancy maps 335, decoded geometry maps 340, decoded attribute maps 345, and decoded metadata 350 using one or more reconstruction filters and techniques. In some embodiments, the metadata 330 may be directly transmitted to decoder 351 and the decoder 351 may use the metadata to generate the reconstructed mesh 360 based on the decoded occupancy maps 335, decoded geometry maps 340, and decoded attribute maps 345. Post-filtering techniques, including but not limited to remeshing, parameterization, tracking, voxelization, etc., may also be applied on the reconstructed mesh 360.

The input meshes with 2D UV atlases may have vertices, where each vertex of the mesh may have an associated UV coordinates on the 2D atlas. The occupancy, geometry, and attribute maps may be generated by sampling one or more points/positions on the UV atlas. Each sample position, if it is inside a polygon defined by the mesh vertices, may be occupied or unoccupied. For each occupied sample, one can calculate its corresponding 3D geometry coordinates and attributes by interpolating from the associated polygon vertices.

According to an aspect of the present disclosure, the sampling rate may be consistent over the whole 2D atlas. In some embodiments, the sampling rate for u and v axes may be different, making anisotropic remeshing possible. In some embodiments, the whole 2D atlas may be divided into multiple regions, such as slices or tiles, and each such region may have a different sampling rate.

According to an aspect of the present disclosure, the sampling rate for each region (or the entire 2D atlas) may be signaled in a high-level syntax, including but not limited to sequence header, frame header, slice header, etc. In some embodiments, sampling rate for each region (or the entire 2D atlas) may be chosen from a pre-established set of rates that have been assumed by both the encoder and decoder. Because the pre-established set of rates that are known by both the encoder and decoder, signaling of one particular sampling rate would require only signaling the index in the pre-established rate set. An example of such a pre-established set may be every 2 pixels, every 4 pixels, every 8 pixels, etc. In some embodiments, the sampling rate for each region (or the entire 2D atlas) of a mesh frame may be predicted from a pre-established rate set, from a previously used sampling rate in other already coded regions of the same frame, or from a previously used sampling rate in other already coded mesh frames.

In some embodiments, the sampling rate for each region (or the entire 2D atlas) may be based on some characteristic of each region (or the entire 2D atlas). As an example, the sample rate can be based on activity—for a rich-textured region (or the entire 2D atlas), or a region (or the entire 2D atlas) with high activity, the sample rate could be set higher. As another example, for a smooth region (or the entire 2D atlas), or a region (or the entire 2D atlas with low activity, the sample rate could be set lower.

In some embodiments, the sampling rate for each region (or the entire 2D atlas) of a mesh frame may be signaled in a way that combination of prediction and direct signaling may be allowed. The syntax may be structured to indicate if a sampling rate will be predicted or directly signaled. When predicted, which of the predictor-sampling rate to be used may be further signaled. When directly signaled, the syntax to represent the value of the rate may be signaled.

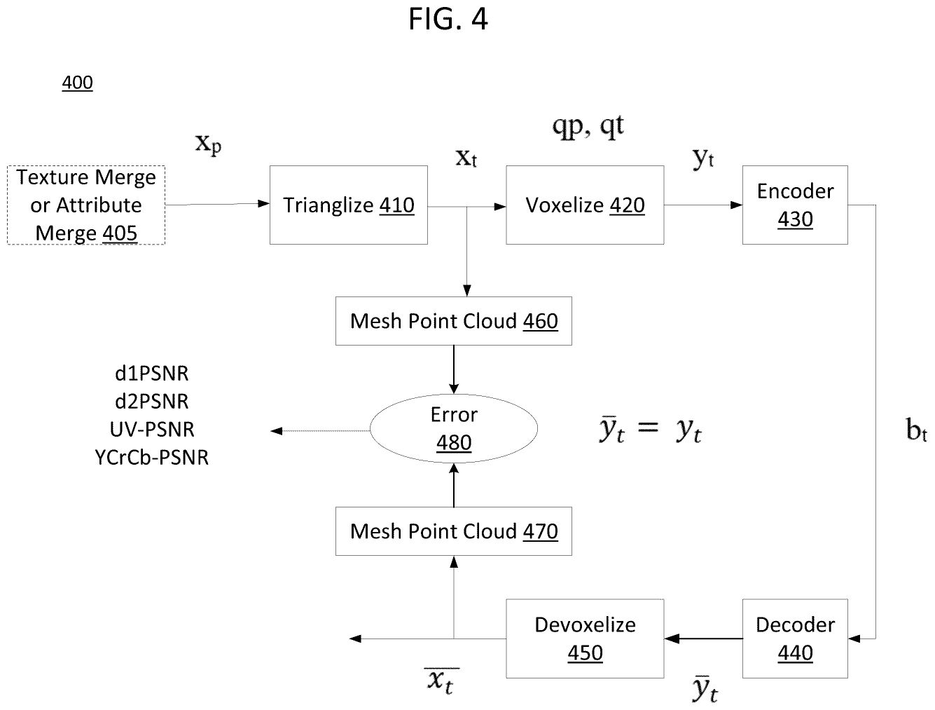

FIG. 4 illustrates a framework 400 for common text condition for lossy mesh compression. In related art, the process for common text condition for lossy mesh compression may, during encoding, include trianglizing 410, voxelizing 420, and encoding 430. The decoding may include decoding 440, devoxelizing 450. The process may also include generating mesh point cloud 460 and 470. The generated mesh point cloud 460 and 470 may be used to determine error 480. The error 480 may include D1 PSNR, D2 PSNR, UV PSNR, and YCrCb PSNR. However, this framework leads to inconsistent evaluations of the mesh compression.

To fit in the evaluation system consistently, for those meshes with multiple texture maps, the texture maps may be concatenated to be a single texture map. The UV coordinates of each texture map may be recalculated to the corresponding size and location in the single concatenated texture map. According to an embodiment of the present disclosure, this concatenation and re-computation of the texture or attribute maps may be a pre-process to the framework 400 and improves the evaluation system consistency. This pre-process is shown in framework 400 as texture merge or attribute merge 405.

Embodiments of the present disclosure relate to a method to merge attributes in a mesh. It may be understood by a person skilled in the art that the attributes in a mesh may be normals or textures or any other attributes associated with the mesh. As an example, the embodiments of this disclosure may be used for texture attribute merging. The embodiments of this disclosure may be applied to other attributes (i.e., normals).

Multiple textures maps in a mesh may be of different sizes, and the UV coordinates of each texture map may be in the range [0, 1], the present disclosure relates to concatenating these maps with their original sizes into a single map and calculate the new UV coordinates in the concatenated map.

In some embodiments, some UV coordinates in a mesh are out of the range [0, 1] or cross the boundary of the texture map. The present disclosure also provides specific methods and processes relating to these natures to merge the texture maps and calculate the corresponding new UV coordinates.

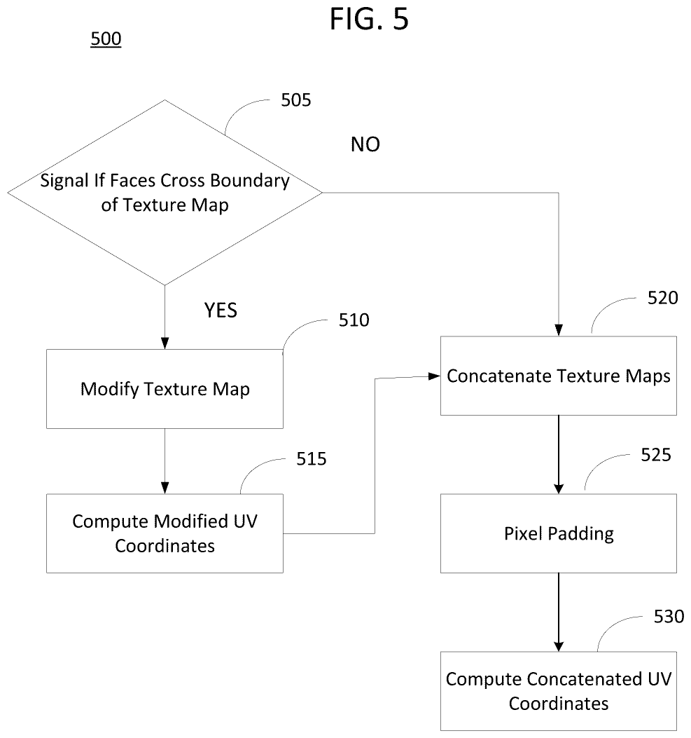

The attribute merging pipeline consisting of the major procedures is shown in FIG. 5. As an example, texture map merging pipeline is described. Faces of the meshes that cross the texture map's boundary may be signaled. If there are faces that cross the boundary of the texture map, the texture map may be modified and the modified UV coordinates computed. After doing this for all the texture maps, the texture maps, including the modified texture maps may be concatenation and pixel padded. The UV coordinates of the mesh may be recomputed for the concatenated map. If there are no faces crossing the boundary of the texture map, the texture maps may be directly merged by concatenation and pixel padding without modifying the texture maps.

FIG. 5 is a flow diagram illustrating a texture map merging process 500, in accordance with embodiments of the present disclosure.

As shown in in process 500, at operation 505, faces of the meshes that cross the texture map's boundary may be signaled. If there are faces that cross the boundary of the texture map, the texture map may be modified in operation 510 and the modified UV coordinates may be computed in operation 515. After doing this for all the texture maps, the texture maps, including the modified texture maps may be concatenation in operation 520 and pixel padded in operation 525. The UV coordinates of the mesh may be recomputed for the concatenated map in operation 530.

However, in embodiments where there are no faces crossing the boundary of the texture map, the texture maps may be directly merged in operation 530 after concatenation in operation 520 and pixel padded in operation 525 without modifying the texture maps in operation 510-515.

According to an embodiment, multiple texture maps are concatenated in 2 dimensions (U and V) as a square. Any appropriate shape may also be used. The number of texture maps is used to compute the width and length of the concatenated texture map as:

N_{length},N_{width}=max(floor(log₂N),2),ceil(log₂N). . . Eqn (1)

where N denotes the total number of texture maps and N_length, N_width denote the number of texture maps in length (vertical) and width (horizontal), respectively.

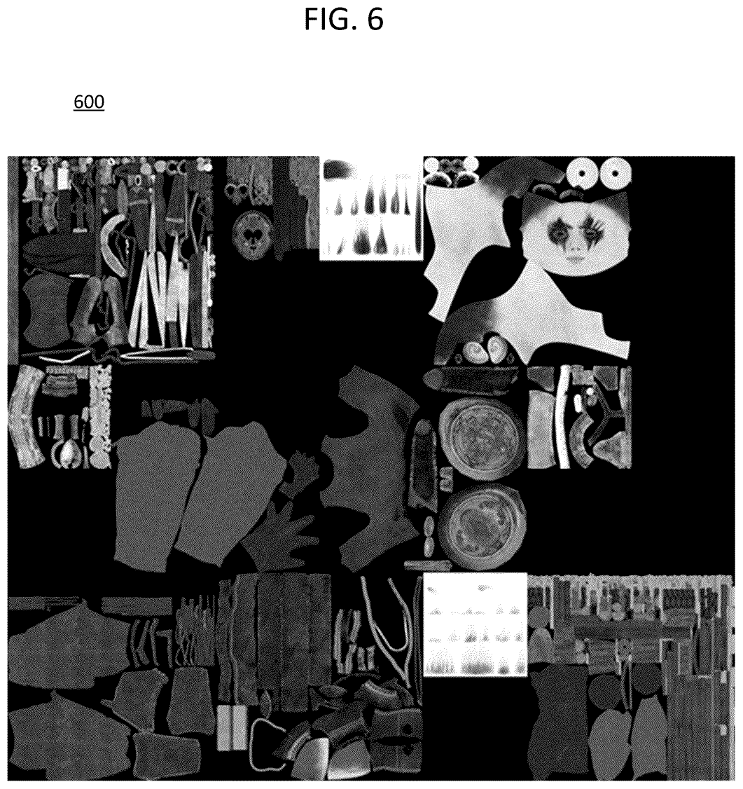

The texture maps may be concatenated in their original size. For the texture maps that have different sizes, pixel padding may be used to fill the empty part between these maps. Pixel padding may be zero padding or non-zero padding. Zero padding may be padding pixels with zero values in RGB (“red-green-blue”) channels. Non-zero padding may be padding pixels with non-zero values in RGB channels. FIG. 6 includes texture maps with zero padding. Non-zero padding may also be used.

FIG. 6 is an exemplary concatenated texture map 600 illustration concatenation and pixel padding, in accordance with embodiments of the present disclosure. As seen in concatenated texture map 600, a concatenated texture map of a mesh “Winter Girl” is provided to illustrate an example of texture map concatenation and pixel padding. In concatenated texture map 600, 12 texture maps are concatenated as a 4×3 concatenated texture map. The empty parts between the texture maps of different sizes are padded zeros.

The original UV coordinates in a texture map are usually in the range [0, 1]. After concatenating texture maps into a single texture map, the original UV coordinates (or modified UV coordinates for texture maps with crossing faces) that reflect the relative position in the individual texture map may be recalculated to fit into the range [0, 1], which reflects the relative position in the newly merged texture map. Thus, the new UV coordinates may be calculated according to the corresponding individual texture map's size and location in the concatenated map. UV coordinates may be normalized with the ratio of the individual texture map size and overall concatenated map size, then shifted to the corresponding location in the concatenated map. The calculation of U and V coordinates may be as below:

$${U}_{n e w} = \frac{( {U}_{o r iginal} \times {width}_{o r iginal} ) + {U}_{offset}}{{width}_{concatenated}} \qquad Eqn ( 2 )$$

$${V}_{n e w} = \frac{( {V}_{o r iginal} \times {length}_{o r iginal} ) + {V}_{offset}}{{length}_{c o n c a t e n a t e d}} \qquad Eqn ( 3 )$$

Where (U_{original}, V_{original}) is the old UV coordinates that reflect the relative position in the original individual texture map; (U_{offset}, V_{offset}) is the location of the individual texture map in the newly merged map in the U and V dimensions, respectively. The location of the point (0, 0) in the individual texture map to may its location in the newly merged texture map.

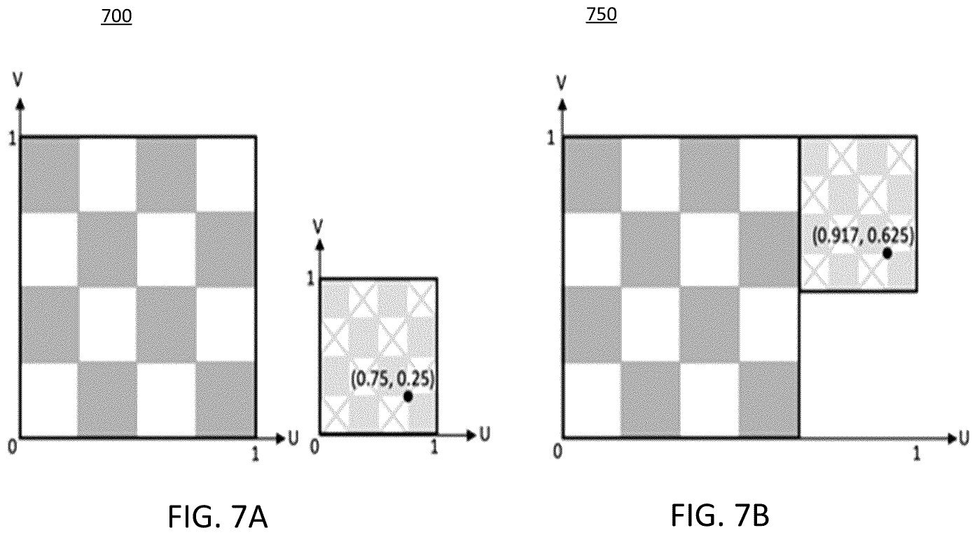

FIG. 7A-7B are exemplary texture maps 700 and 750 respectively illustrating concatenation of texture maps, in accordance with embodiments of the present disclosure.

As seen in FIG. 7A, FIG. 7A includes a big texture map that is 1×1, and a small texture map that is 0.5×0.5. The UV coordinates of the black dot in the small texture map are (0.75, 0.25). FIG. 7B illustrates concatenated texture map 750 that is a concatenation of the two texture maps in FIG. 7A. As shown in FIG. 7B, the new U coordinate of the black dot is computed as (0.75×0.5+1)/1.5=0.917, where the U_{offset} is 1. The new V coordinate of the black dot is computed as (0.25×0.5+0.5)/1=0.625, where the V_{offset} is 0.5.

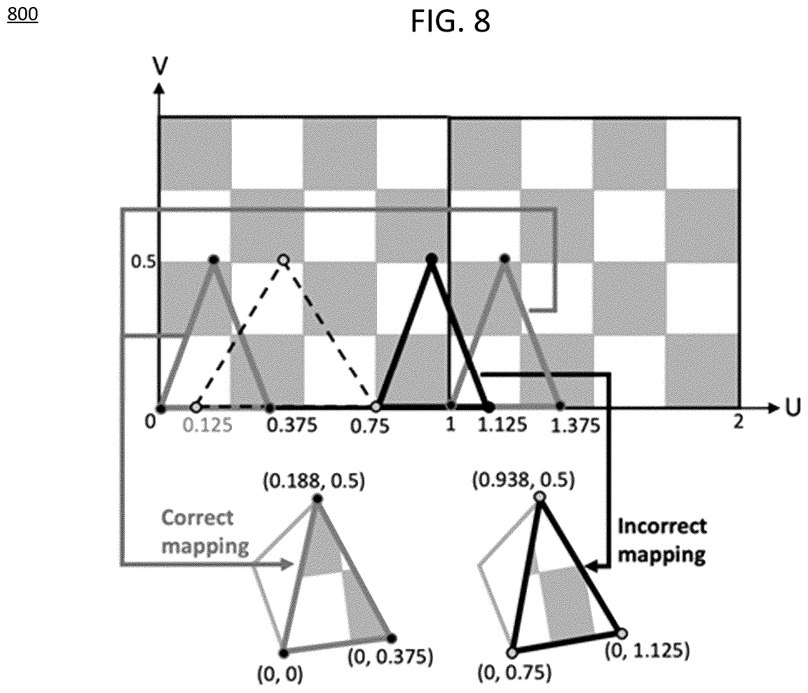

In some embodiments, meshes may have coordinates that are less than 0 or greater than 1. Such coordinates indicate repetition in a map. As an example, FIG. 8 illustrates texture map 800 with a repeating background.

If U (or V) is some parameters where 0<U<1 (or 0<V<1), then U+1, U+2 (or V+1, V+2) and so on are the same location in the texture map. Hence, the UV coordinates may be represented as:

UV=remainder(UV/1.0)+floor(UV/1.0) . . . Eqn (4)

To calculate the new UV coordinates in the concatenated texture map, we normalize and shift the remainder of UV/1.0, then add the floor of UV/1.0 to preserve the texture repetition nature in the UV coordinates.

The color of each face in a mesh may be computed by interpolating the sampled color of UV coordinates in the texture map. FIG. 8 shows the color mapping of a texture map to the faces with different UV coordinates. If the face does not cross the boundary of the texture map, the color mapping may be the same as the color mapping of the remainder of the UV coordinates. As shown in FIG. 8, the UV remainder of the right gray triangle is the same as the UV coordinates of the left gray triangle. Two gray triangles have the same color mapping on the face of the mesh. However, if the face crosses the texture map's boundary as the black triangle, the color sampled by the remainder of UV coordinates would be changed to that of the dashed black triangle and lead to an incorrect color mapping result.

Therefore, the UV coordinates of the face that cross the boundary of the texture map cannot be represented as the remainder of UV/1.0 for the UV bigger than 1 or UV less than 0.

To deal with such a problem, the faces that cross the texture map's boundary in a mesh are signaled. If there are faces that cross the boundary, the texture map having such faces is modified and the modified UV coordinates calculated to ensure that all the faces are in the texture map and that no face crosses the boundary in the modified texture map. If there is no face that crosses the boundary in the original texture maps, the procedures of the texture map modification and the UV coordinates re-computation may be skipped.

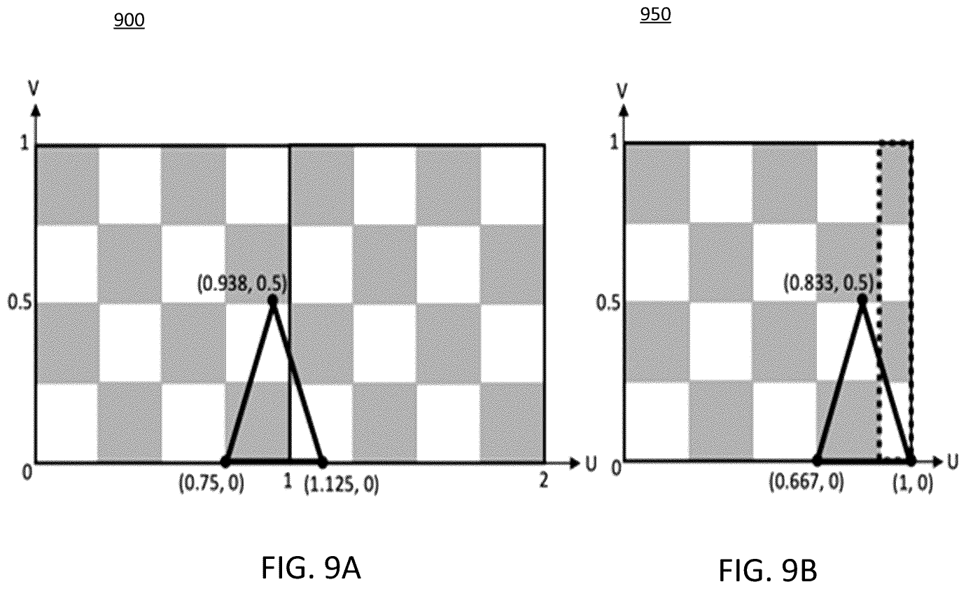

FIG. 9A-9B are exemplary texture maps illustrating concatenation of texture maps, in accordance with embodiments of the present disclosure.

FIG. 9A illustrates an original texture map and UV coordinates that cross the boundary of the texture map. FIG. 9B illustrates a modified texture map and recomputed UV coordinates.

As shown in FIG. 9A, the UV coordinates that cross the right boundary of the texture map have the same color as the UV coordinates close to the left boundary of the texture map. Therefore, the left area of the texture map is copied across the width corresponding to the UV coordinates crossing the boundary and pasted to the right side of the texture map. The modified UV coordinates for the modified texture maps may be computed based on the location and the size of the copied areas.

In an embodiment, if the copied area is on the right side:

$${U}_{n e w} = \frac{{U}_{o r iginal}}{{width}_{o r iginal} + {width}_{c o p i e {d}_{a r e a}}} \qquad Eqn ( 5 )$$

In an embodiment, if the copied area is on the left side:

U_{new}=(U_{original}+width_{copied}_{ₐᵣₑₐ})+/(width_{original}+width_{copied}_{ₐᵣₑₐ})⁺. . . Eqn (6)

In an embodiment, if the copied area is on the top side:

V_{new}=V_{original}/(length_{original}+length_{copied_area}) . . . Eqn (7)

In an embodiment, if the copied area is on the bottom side:

V_{new}=(V_{original}+length_{copied_area})+/(length_{original}+length_{copied_area}) . . . Eqn (8)

FIG. 9B illustrates the copied and pasted area in the dashed black lines in the modified texture map. As shown in FIG. 9B, the copied area is on the right side of the original texture map and its width is 0.125. The three new UV coordinates may be computed as (0.75/1.125, 0), (1.125/1.125, 0), (0.938/1.125, 0.5), which are equal to (0.667, 0), (1, 0), (0.833, 0.5). After computing the new UV coordinates, there is no face in the mesh that crosses the boundary of the texture map. Thus, the remainder of UV/1 for UV outside [0, 1] may be used to merge all the texture maps.

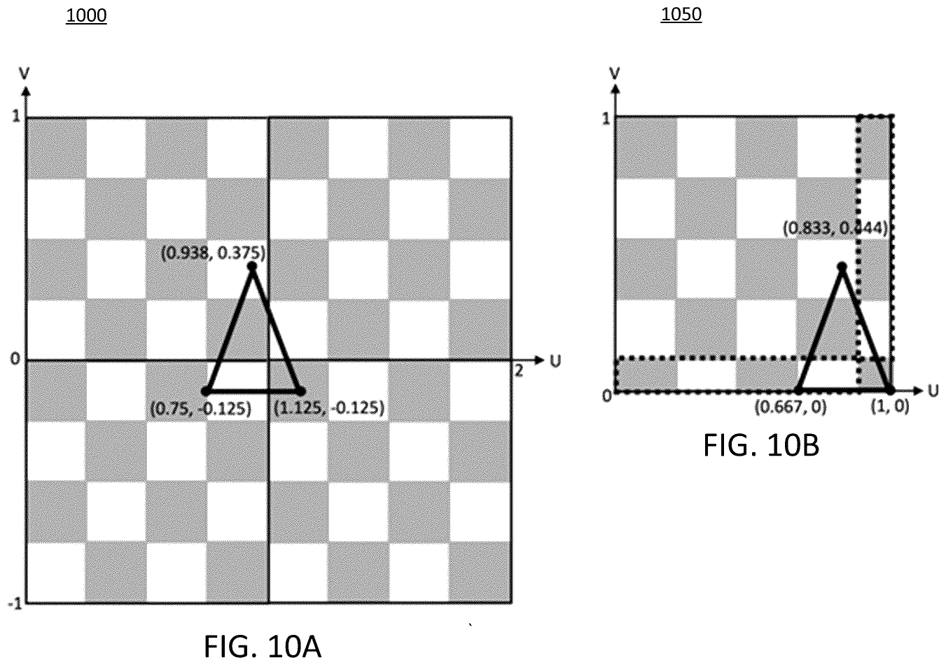

FIG. 10A-10B are exemplary texture maps illustrating concatenation of texture maps, in accordance with embodiments of the present disclosure.

FIG. 10A illustrates an example when both U and V coordinates cross the boundary of the texture map. Due to the repetitive nature of UV coordinates, the bottom right point outside the texture map is equal to the top left point in the texture map. The cross-boundary area is copied and pasted to modify the texture map and re-compute the UV coordinates as mentioned in the present disclosure.

FIG. 10B illustrates the modified texture map including the three new UV coordinates which are (0.75/1.125, (−1.125+1.125)/1.125), (1.125/1.125, (−1.125+1.125)/1.125), (0.938/1.125, (0.375+0.125)/1.125), which are equal to (0.667, 0), (1, 0), (0.833, 0.444) in the modified texture map.

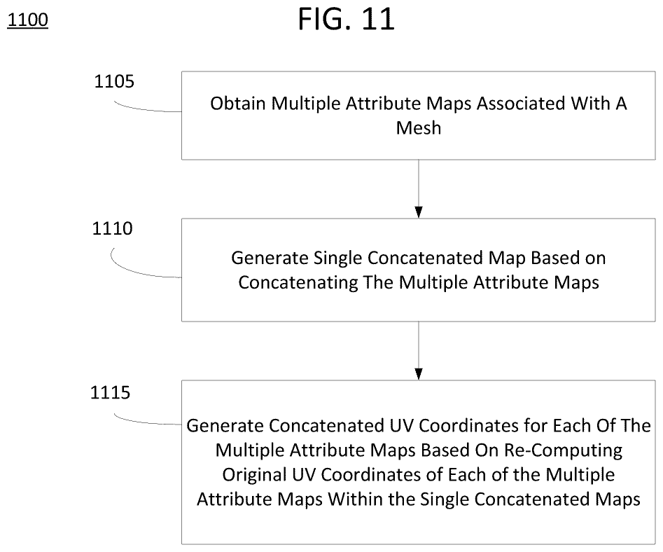

FIG. 11 illustrates an exemplary process 1100 for merging multiple attribute maps for mesh compression.

In operation 1105, multiple attribute maps associated with a mesh may be obtained.

In some embodiments, the multiple attribute maps comprise two or more texture maps associated with the mesh. The multiple maps may include any appropriate type of attribute map.

In operation 1110, a single concatenated map based on concatenating the multiple attribute maps may be generated.

In some embodiments, the multiple attribute maps in 2D may be concatenated, and a length and a breadth of the single concatenated map may be based on a number of attribute maps included in the multiple attribute maps. In some embodiments, empty pixels between the multiple attribute maps in the single concatenated map may be padded with a padding value. In some embodiments, the padding may include assigning RGB channels in the empty pixels with zero values or non-zero values.

In operation 1115, concatenated UV coordinates for each of the multiple attribute maps may be generated based on re-computing original UV coordinates of each of the multiple attribute maps within the single concatenated map.

In some embodiments, generating the concatenated UV coordinates may include determining the original UV coordinates for each of the multiple attribute maps within the single concatenated map and determining an offset for the original UV coordinates for each of the multiple attribute maps within the single concatenated map. The operation may also include generating the concatenated UV coordinates for each of the multiple attribute maps within the single concatenated map based on the original UV coordinates and the offset for the original UV coordinates.

In some embodiments, when a texture map among the multiple attribute maps has a repetition of a pattern, the concatenated UV coordinates the first texture map may be generated based on a normalized shifting of a remainder of the original UV coordinates for the first texture map.

In some embodiments, prior to operation 1110, the process may include determining that one or more faces of at least one texture map among the multiple attribute maps crosses a boundary of the at least one texture map and then signaling the one or more faces that cross the boundary of the at least one texture map. A respective area of the at least one texture map corresponding to a width or a height of each respective face of the one or more faces that cross the boundary of the at least one texture map may be repeated.

A modified texture map of the at least one texture map may be generated with modified UV coordinates based on a respective location of the respective repeated area and a respective size of the respective repeated area. Finally, the single concatenated map may be generated based on concatenating the modified texture map and the multiple attribute maps.

It may be understood that the process 1100 may be performed for any type of maps used in mesh compression, including attribute maps, texture maps, etc.

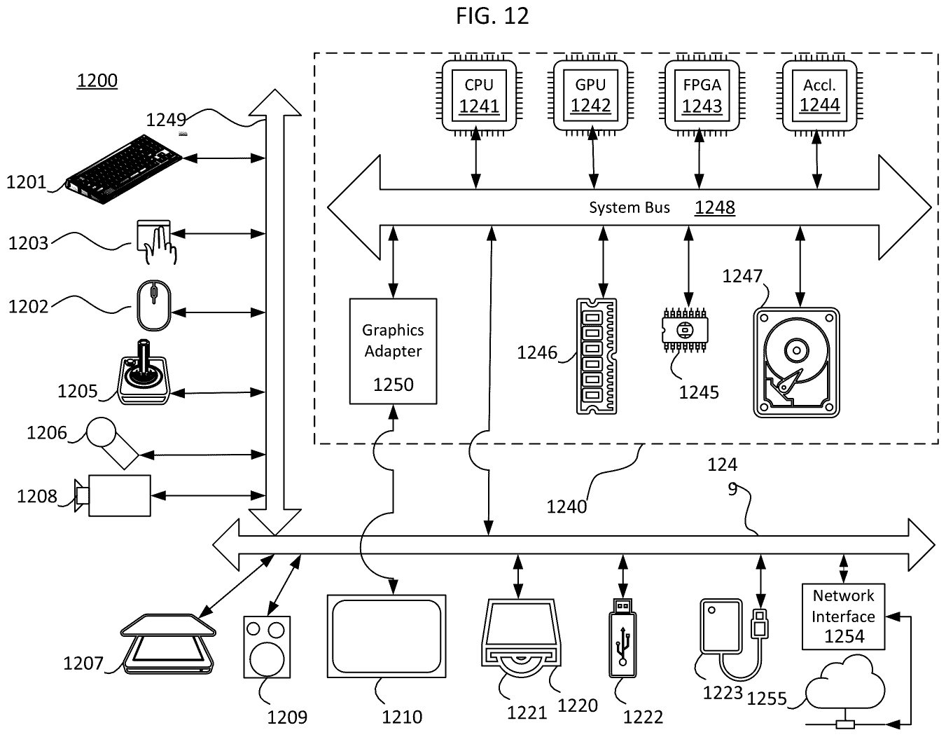

The techniques, described above, can be implemented as computer software using computer-readable instructions and physically stored in one or more computer-readable media. For example, FIG. 12 shows a computer system 1200 suitable for implementing certain embodiments of the disclosure.

The computer software can be coded using any suitable machine code or computer language, that may be subject to assembly, compilation, linking, or like mechanisms to create code including instructions that can be executed directly, or through interpretation, micro-code execution, and the like, by computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 12 for computer system 1200 are examples and are not intended to suggest any limitation as to the scope of use or functionality of the computer software implementing embodiments of the present disclosure. Neither should the configuration of components be interpreted as having any dependency or requirement relating to any one or combination of components illustrated in the non-limiting embodiment of a computer system 1200.

Computer system 1200 may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard 1201, mouse 1202, trackpad 1203, touch screen 1210, data-glove, joystick 1205, microphone 1206, scanner 1207, camera 1208.

Computer system 1200 may also include certain human interface output devices. Such human interface output devices may be stimulating the senses of one or more human users through, for example, tactile output, sound, light, and smell/taste. Such human interface output devices may include tactile output devices (for example tactile feedback by the touch-screen 1210, data glove, or joystick 1205, but there can also be tactile feedback devices that do not serve as input devices). For example, such devices may be audio output devices (such as: speakers 1209, headphones (not depicted)), visual output devices (such as screens 1210 to include CRT screens, LCD screens, plasma screens, OLED screens, each with or without touch-screen input capability, each with or without tactile feedback capability—some of which may be capable to output two dimensional visual output or more than three dimensional output through means such as stereographic output; virtual-reality glasses (not depicted), holographic displays and smoke tanks (not depicted)), and printers (not depicted).

Computer system 1200 can also include human accessible storage devices and their associated media such as optical media including CD/DVD ROM/RW 1220 with CD/DVD or the like media 1221, thumb-drive 1222, removable hard drive or solid state drive 1223, legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system 1200 can also include interface to one or more communication networks. Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses 1249 (such as, for example USB ports of the computer system 1200; others are commonly integrated into the core of the computer system 1200 by attachment to a system bus as described below (for example Ethernet interface into a PC computer system or cellular network interface into a smartphone computer system). Using any of these networks, computer system 1200 can communicate with other entities. Such communication can be uni-directional, receive only (for example, broadcast TV), uni-directional send-only (for example CANbus to certain CANbus devices), or bi-directional, for example to other computer systems using local or wide area digital networks. Such communication can include communication to a cloud computing environment 1255. Certain protocols and protocol stacks can be used on each of those networks and network interfaces as described above.

Aforementioned human interface devices, human-accessible storage devices, and network interfaces 1254 can be attached to a core 1240 of the computer system 1200.

The core 1240 can include one or more Central Processing Units (CPU) 1241, Graphics Processing Units (GPU) 1242, specialized programmable processing units in the form of Field Programmable Gate Areas (FPGA) 1243, hardware accelerators for certain tasks 1244, and so forth. These devices, along with Read-only memory (ROM) 1245, Random-access memory 1246, internal mass storage such as internal non-user accessible hard drives, SSDs, and the like 1247, may be connected through a system bus 1248. In some computer systems, the system bus 1248 can be accessible in the form of one or more physical plugs to enable extensions by additional CPUs, GPU, and the like. The peripheral devices can be attached either directly to the core's system bus 1248, or through a peripheral bus 1249. Architectures for a peripheral bus include PCI, USB, and the like. A graphics adapter 1250 may be included in the core 1240.

CPUs 1241, GPUs 1242, FPGAs 1243, and accelerators 1244 can execute certain instructions that, in combination, can make up the aforementioned computer code. That computer code can be stored in ROM 1245 or RAM 1246. Transitional data can be also be stored in RAM 1246, whereas permanent data can be stored for example, in the internal mass storage 1247. Fast storage and retrieve to any of the memory devices can be enabled through the use of cache memory, that can be closely associated with one or more CPU 1241, GPU 1242, mass storage 1247, ROM 1245, RAM 1246, and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, a computer system having the architecture of computer system 1200, and specifically the core 1240 can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core 1240 that are of non-transitory nature, such as core-internal mass storage 1247 or ROM 1245. The software implementing various embodiments of the present disclosure can be stored in such devices and executed by core 1240. A computer-readable medium can include one or more memory devices or chips, according to particular needs. The software can cause the core 1240 and specifically the processors therein (including CPU, GPU, FPGA, and the like) to execute particular processes or particular parts of particular processes described herein, including defining data structures stored in RAM 1246 and modifying such data structures according to the processes defined by the software. In addition or as an alternative, the computer system can provide functionality as a result of logic hardwired or otherwise embodied in a circuit (for example: accelerator 1244), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

While this disclosure has described several non-limiting embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A method for merging multiple attribute maps for mesh compression, the method being executed by at least one processor, the method comprising:
obtaining multiple attribute maps associated with a mesh, wherein the multiple attribute maps comprise two or more texture maps associated with the mesh;
generating a single concatenated map based on concatenating the multiple attribute maps; and
generating concatenated UV coordinates for each of the multiple attribute maps based on re-computing original UV coordinates of each of the multiple attribute maps within the single concatenated map.

2. The method of claim 1, wherein the generating the single concatenated map comprises:
concatenating the multiple attribute maps in 2D, wherein a length and a breadth of the single concatenated map is based on a number of attribute maps included in the multiple attribute maps; and
padding empty pixels between the multiple attribute maps in the single concatenated map with a padding value.

3. The method of claim 2, wherein the padding value is zero, and wherein the padding comprises assigning red-green-blue (RGB) channels in the empty pixels with zero values.

4. The method of claim 2, wherein the padding value is non-zero, and wherein the padding comprises assigning RGB channels in the empty pixels with non-zero values.

5. The method of claim 1, wherein generating the concatenated UV coordinates comprises:
determining the original UV coordinates for each of the multiple attribute maps within the single concatenated map;
determining an offset for the original UV coordinates for each of the multiple attribute maps within the single concatenated map; and
generating the concatenated UV coordinates for each of the multiple attribute maps within the single concatenated map based on the original UV coordinates and the offset for the original UV coordinates.

6. The method of claim 5, wherein based on determining that a first texture map among the multiple attribute maps has a repetition of a pattern, generating the concatenated UV coordinates the first texture map is based on a normalized shifting of a remainder of the original UV coordinates for the first texture map.

7. The method of claim 1, wherein, prior to generating the single concatenated map, the method further comprises:
based on one or more faces of at least one texture map among the multiple attribute maps crossing a boundary of the at least one texture map, signaling the one or more faces that cross the boundary of the at least one texture map;
repeating a respective area of the at least one texture map corresponding to a width or a height of each respective face of the one or more faces that cross the boundary of the at least one texture map;
generating a modified texture map of the at least one texture map with modified UV coordinates based on a respective location of the respective repeated area and a respective size of the respective repeated area; and
generating the single concatenated map based on concatenating the modified texture map and the multiple attribute maps, wherein the multiple attribute maps do not comprise the at least one texture map used to generate the modified texture map.

8. An apparatus for merging multiple attribute maps for mesh compression, the apparatus comprising:
at least one memory configured to store program code; and
at least one processor configured to read the program code and operate as instructed by the program code, the program code including:
obtaining code configured to cause the at least one processor to obtain multiple attribute maps associated with a mesh, wherein the multiple attribute maps comprise two or more texture maps associated with the mesh;
first generating code configured to cause the at least one processor to generate a single concatenated map based on concatenating the multiple attribute maps; and
second generating code configured to cause the at least one processor to generate concatenated UV coordinates for each of the multiple attribute maps based on re-computing original UV coordinates of each of the multiple attribute maps within the single concatenated map.

9. The apparatus of claim 8, wherein the first generating code comprises:
first concatenating code configured to cause the at least one processor to concatenate the multiple attribute maps in 2D, wherein a length and a breadth of the single concatenated map is based on a number of attribute maps included in the multiple attribute maps; and
padding code configured to cause the at least one processor to pad empty pixels between the multiple attribute maps in the single concatenated map with a padding value.

10. The apparatus of claim 9, wherein the padding value is zero, and wherein the padding comprises assigning red-green-blue (RGB) channels in the empty pixels with zero values.

11. The apparatus of claim 9, wherein the padding value is non-zero, and wherein the padding comprises assigning RGB channels in the empty pixels with non-zero values.

12. The apparatus of claim 8, wherein the second generating code comprises:
first determining code configured to cause the at least one processor to determine the original UV coordinates for each of the multiple attribute maps within the single concatenated map;
second determining code configured to cause the at least one processor to determine an offset for the original UV coordinates for each of the multiple attribute maps within the single concatenated map; and
third generating code configured to cause the at least one processor to generate the concatenated UV coordinates for each of the multiple attribute maps within the single concatenated map based on the original UV coordinates and the offset for the original UV coordinates.

13. The apparatus of claim 12, wherein based on determining that a first texture map among the multiple attribute maps has a repetition of a pattern, generating the concatenated UV coordinates the first texture map is based on a normalized shifting of a remainder of the original UV coordinates for the first texture map.

14. The apparatus of claim 8, wherein the method further comprises:
based on one or more faces of at least one texture map among the multiple attribute maps crossing a boundary of the at least one texture map, signaling code configured to cause the at least one processor to signal the one or more faces that cross the boundary of the at least one texture map;
repeating code configured to cause the at least one processor to repeat a respective area of the at least one texture map corresponding to a width or a height of each respective face of the one or more faces that cross the boundary of the at least one texture map;
fourth generating code configured to cause the at least one processor to generate a modified texture map of the at least one texture map with modified UV coordinates based on a respective location of the respective repeated area and a respective size of the respective repeated area; and
fifth generating code configured to cause the at least one processor to generate the single concatenated map based on concatenating the modified texture map and the multiple attribute maps, wherein the multiple attribute maps do not comprise the at least one texture map used to generate the modified texture map.

15. A non-transitory computer-readable medium storing instructions, the instructions comprising: one or more instructions that, when executed by one or more processors of a device for merging multiple attribute maps for mesh compression, cause the one or more processors to:
obtain multiple attribute maps associated with a mesh, wherein the multiple attribute maps comprise two or more texture maps associated with the mesh;
generate a single concatenated map based on concatenating the multiple attribute maps; and
generate concatenated UV coordinates for each of the multiple attribute maps based on re-computing original UV coordinates of each of the multiple attribute maps within the single concatenated map.

16. The non-transitory computer-readable medium of claim 15, wherein the generating the single concatenated map comprises:
concatenating the multiple attribute maps in 2D, wherein a length and a breadth of the single concatenated map is based on a number of attribute maps included in the multiple attribute maps; and
padding empty pixels between the multiple attribute maps in the single concatenated map with a padding value.

17. The non-transitory computer-readable medium of claim 16, wherein the padding value is zero, and wherein the padding comprises assigning red-green-blue (RGB) channels in the empty pixels with zero values.

18. The non-transitory computer-readable medium of claim 15, wherein generating the concatenated UV coordinates comprises:
determining the original UV coordinates for each of the multiple attribute maps within the single concatenated map;
determining an offset for the original UV coordinates for each of the multiple attribute maps within the single concatenated map; and
generating the concatenated UV coordinates for each of the multiple attribute maps within the single concatenated map based on the original UV coordinates and the offset for the original UV coordinates.

19. The non-transitory computer-readable medium of claim 18, wherein based on determining that a first texture map among the multiple attribute maps has a repetition of a pattern, generating the concatenated UV coordinates the first texture map is based on a normalized shifting of a remainder of the original UV coordinates for the first texture map.

20. The non-transitory computer-readable medium of claim 15, wherein, prior to generating the single concatenated map, the one or more instructions, when executed by the one or more processors, further cause the one or more processors to:
based on one or more faces of at least one texture map among the multiple attribute maps crossing a boundary of the at least one texture map, signal the one or more faces that cross the boundary of the at least one texture map;
repeat a respective area of the at least one texture map corresponding to a width or a height of each respective face of the one or more faces that cross the boundary of the at least one texture map;
generate a modified texture map of the at least one texture map with modified UV coordinates based on a respective location of the respective repeated area and a respective size of the respective repeated area; and
generate the single concatenated map based on concatenating the modified texture map and the multiple attribute maps, wherein the multiple attribute maps do not comprise the at least one texture map used to generate the modified texture map.
